(19) United States
(12) Patent Application Publication
(10) Pub. No.: US 2026/0012833 A1
(43) Pub. Date: Jan. 8, 2026

(54) USER EQUIPMENT AND CSI REPORT GENERATING METHOD PERFORMED BY THE SAME IN WIRELESS COMMUNICATION SYSTEM

(71) Applicant: SAMSUNG ELECTRONICS CO., LTD., Suwon-si (KR)

(72) Inventors: Hyun Jae PARK, Suwon-si (KR); Kihun KIM, Suwon-si (KR); Hyun Kuk CHOI, Suwon-si (KR); Yookeun KANG, Suwon-si (KR); Ki-Ho KIL, Suwon-si (KR)

(73) Assignee: SAMSUNG ELECTRONICS CO., LTD., Suwon-si (KR)

(21) Appl. No.: 19/237,738

(22) Filed: Jun. 13, 2025

(30) Foreign Application Priority Data
Jul. 5, 2024 (KR) 10-2024-0088859

(51) Int. Cl. H04W 24/10; H04B 17/309; H04L 5/00

(52) U.S. Cl. CPC H04W 24/10; H04B 17/309; H04L 5/0048

(57) ABSTRACT

A user equipment includes: a communication circuit configured to receive, from a serving base station, a plurality of first reference signals transmitted through a plurality of transmission beams; and a processor configured to measure signal quality metrics of the plurality of first reference signals and generate a channel state information (CSI) report based on the measured signal quality metrics, wherein the communication circuit is further configured to receive, through a plurality of first antenna ports, at least one second reference signal from the serving base station, and the processor is further configured to generate, based on the at least one second reference signal and the CSI report, an updated CSI report.

### CROSS-REFERENCE TO RELATED APPLICATION

This application claims priority to Korean Patent Application No. 10-2024-0088859, filed in the Korean Intellectual Property Office on Jul. 5, 2024, the entire contents of which are incorporated by reference herein.

### BACKGROUND

### 1. Field

The disclosure relates to a user equipment (UE) and a channel state information (CSI) report generating method performed by the user equipment in a wireless communication system.

### 2. Description of Related Art

Cellular communication systems including fifth generation (5G) communication systems periodically measure a reference signal received power (RSRP) of a base station to which a terminal is currently connecting and the RSRPs of surrounding base stations around the base station to support mobility functions. The terminal may compare the RSRP of the currently connecting base station with the RSRPs of the surrounding base stations to perform handover to another base station with a high RSRP.

However, in a multiple-input multiple-output (MIMO) wireless communication environment, base stations and terminals transmit and receive data using a plurality of antenna ports. It is difficult to reflect the characteristics of this MIMO wireless communication environment with the related method. As a result, it is difficult for the terminal to propose the best beam direction for data transmission and reception with the base station.

### SUMMARY

Provided are a user equipment and a CSI report generating method performed by the user equipment in a wireless communication system.

Aspects of the disclosure are not limited to those described below, and other aspects not explicitly described herein may be understood by those skilled in the art from the description of the disclosure.

According to an aspect of the disclosure, a user equipment includes: a communication circuit configured to receive, from a serving base station, a plurality of first reference signals transmitted through a plurality of transmission beams; and a processor configured to measure signal quality metrics of the plurality of first reference signals and generate a channel state information (CSI) report based on the measured signal quality metrics, wherein the communication circuit is further configured to receive, through a plurality of first antenna ports, at least one second reference signal from the serving base station, and the processor is further configured to generate, based on the at least one second reference signal and the CSI report, an updated CSI report.

According to an aspect of the disclosure, a user equipment includes: a communication circuit configured to: receive, from a serving base station, a plurality of first reference signals transmitted through a plurality of transmission beams, and receive, through a plurality of first antenna ports, a plurality of second reference signals, each second reference signal of the plurality of second reference signals having a quasi-colocation (QCL) relationship with a respective first reference signal of the plurality of first reference signals; and a processor configured to: determine a capacity of each channel of a plurality of channels that transmit the plurality of second reference signals, and generate a CSI report such that a signal quality metric of a specific first reference signal is a strongest signal quality metric, wherein the specific first reference signal has a QCL relationship with a specific second reference signal transmitted through a channel having a greatest capacity among the plurality of channels, and the communication circuit is further configured to transmit the generated CSI report to the serving base station.

According to an aspect of the disclosure, a method for generating a channel state information (CSI) report, includes: receiving, by a communication circuit of a user equipment, from a serving base station, a plurality of first reference signals transmitted through a plurality of transmission beams; measuring, by a processor of the user equipment, signal quality metrics of the plurality of first reference signals; based on the measured signal quality metrics, generating, by the processor, the CSI report; receiving, by the communication circuit, at least one second reference signal from the serving base station through a plurality of first antenna ports; and based on the CSI report and the at least one second reference signal received through the plurality of first antenna ports, generating, by the processor, an updated CSI report.

Various and beneficial advantages and effects of the disclosure are not limited to those described above, and will be understood in the course of describing specific aspects of the disclosure.

### BRIEF DESCRIPTION OF THE DRAWINGS

The above and other objects, features and advantages of the disclosure will become more apparent to those of ordinary skill in the art by describing in detail example embodiments thereof with reference to the accompanying drawings, in which:

FIG. 1 illustrates an example of wireless network according to some embodiments of the disclosure;

FIG. 2 illustrates an example of beamforming-based communication between a next generation node B (gNB) and a user equipment (UE);

FIG. 3 illustrates an example of the gNB according to some embodiments of the disclosure;

FIG. 4 illustrates an example of the UE according to some embodiments of the disclosure;

FIG. 5 illustrates a process of generating a channel state information (CSI) report;

FIG. 6 illustrates a process of updating a CSI report;

FIG. 7 illustrates an operation S620 of FIG. 6 in detail;

FIG. 8A illustrates an operation S710 of FIG. 7;

FIG. 8B illustrates an operation S720 of FIG. 7;

FIG. 9 illustrates a process of updating a CSI report;

FIG. 10 illustrates a modification of FIG. 9;

FIG. 11 illustrates a process of performing validity verification and update of a CSI report;

FIG. 12 illustrates an operation S1170 of FIG. 11 in detail;

FIG. 13 illustrates illustrating a process of verifying and updating a CSI report; and

FIG. 14 illustrates a process performed as the updated CSI report is transmitted to a gNB.

### DETAILED DESCRIPTION

The terms as used in the disclosure are provided to merely describe specific embodiments, not intended to limit the scope of other embodiments. Singular forms include plural referents unless the context clearly dictates otherwise. The terms and words as used herein, including technical or scientific terms, may have the same meanings as generally understood by those skilled in the art. The terms as generally defined in dictionaries may be interpreted as having the same or similar meanings as or to contextual meanings of the relevant art. Unless otherwise defined, the terms should not be interpreted as ideally or excessively formal meanings. Even though a term is defined in the disclosure, the term should not be interpreted as excluding embodiments of the disclosure under circumstances.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Moreover, multiple functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

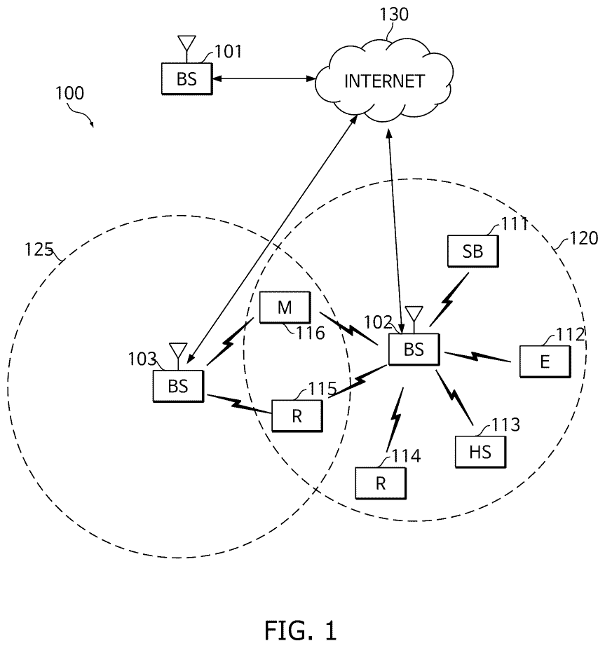

FIG. 1 illustrates an example wireless network 100. Other aspects of the wireless network 100 may be used without departing from the scope of the disclosure.

As illustrated in FIG. 1, the wireless network 100 may include a next generation node B (gNB) 101 (e.g., a serving base station (BS)), a gNB 102 and a gNB 103. The gNB 101 may be in communication with the gNB 102 and the gNB 103. The gNB 101 may also be in communication with at least one network 130, such as the Internet, proprietary Internet Protocol (IP) networks, or other data networks.

The gNB 102 may provide a first plurality of user equipments (UEs) within a coverage area 120 of the gNB 102 with a wireless broadband access to the network 130. The first plurality of UEs may include a UE 111 that may be located in a small business (SB), a UE 112 that may be located in an enterprise (E), a UE 113 that may be located in a Wi-Fi hot spot (HS), a UE 114 that may be located in a first residence (R), a UE 115 that may be located in a second residence (R), and a UE 116 that may be a mobile device (M) such as a cell phone, a wireless laptop, or a wireless PDA.

The gNB 103 may provide a second plurality of UEs within a coverage area 125 of the gNB 103 with a wireless broadband access to the network 130. The second plurality of UEs may include the UE 115 and the UE 116. In some aspects, one or more of the gNBs 101, 102, and 103 may be in communication with each other and in communication with the UEs 111 to 116 using 5G/NR, long term evolution (LTE), long term evolution-advanced (LTE-A), WiMAX, WiFi, or other wireless communication technologies.

According to the type of network, the terms “base station”, “serving base station”, or “BS” may refer to any component (or set of components) established to provide wireless access to a network, such as a transmission point (TP), a transmission-receiving point (TRP), an enhanced base station (eNodeB or eNB), a 5G base station (gNB), a macrocell, a femtocell, an access point (AP), or other wirelessly enabled devices. The base station may provide the wireless access according to one or more wireless communication protocols. For example, the base station may provide the wireless access according to 5G/NR, long term evolution (LTE), LTE-advanced (LTE-A), high speed packet access (HSPA), Wi-Fi 802.11a/b/g/n/ac, etc. For convenience, the terms “BS” and “TRP” may be used herein to refer to a network infrastructure component that provides a remote terminal with wireless access. In addition, depending on the network type, the term “user equipment” or “UE” may refer to any component such as “mobile station”, “subscriber station”, “remote terminal”, “wireless terminal”, “receiving point”, or “user equipment”. For convenience, the terms “user equipment” and “UE” may be used herein to refer to a remote wireless device, such as a mobile device, stationary device, etc., through which the UE wirelessly accesses the BS.

The dotted line in the drawing shows an approximate range of the coverage areas 120 and 125 that are illustrated substantially circular for illustration and description only. It should be clearly understood that the coverage areas associated with the gNB, such as the coverage areas 120 and 125, may have different shapes including irregular shapes, depending on the setting of the gNB and changes in the radio environment associated with natural and man-made obstructions.

As described in more detail below, one or more of the UEs 111 to 116 may include circuitry, programming, or a combination thereof for UE beam activation in a wireless communication system. In certain aspects, one or more of the gNBs 101, 102, and 103 may include circuitry, programming, or a combination thereof for UE beam activation in a wireless communication system.

FIG. 1 illustrates an example of the wireless network 100 according to some embodiments of the disclosure, but various changes to FIG. 1 may be possible. For example, the wireless network 100 may include any number of gNBs and any number of UEs in any suitable arrangement. In addition, the gNB 101 may communicate directly with any number of UEs and provide these UEs with the wireless broadband access to the network 130. Likewise, each of the gNBs 102 and 103 may communicate directly with the network 130 and provide the UE with a direct wireless broadband access to the network. In addition, the gNBs 101, 102, and/or 103 may provide access to other or additional external networks, such as external telephone networks or other types of data networks.

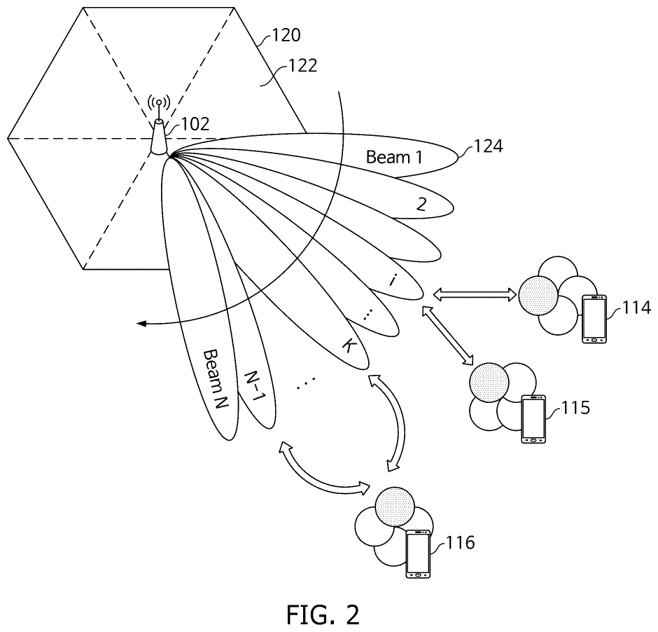

FIG. 2 illustrates an example of beamforming-based communication between the gNB 102 and the UEs 114, 115, and 116. Each of the UEs 114, 115, and 116 may correspond to any one of the UEs 111 to 116 of FIG. 1. The coverage area 120 of the gNB 102 may include a plurality of sectors 122. The gNB 102 may operate multi-beams for each sector 122. The gNB 102 may form one or more transmission beams and reception beams for a downlink and uplink by sweeping the beams simultaneously or sequentially in different directions to support one or more UEs while acquiring a beamforming gain.

As an example, the gNB 102 may simultaneously form N transmission beams (Beams 1 to N, where, N is any natural number) directed in N directions during N slots. As another example, the gNB 102 may sequentially form N transmission beams directed in N directions during N slots. This may be referred to as sweeping. For example, a first transmission beam may be formed only in a first slot, a second transmission beam may be formed in a second slot, an i-th transmission beam may be formed in an i-th slot, and an N-th transmission beam may be formed in an N-th slot.

Due to its structural limitations, the UEs 114, 115, and 116 may generally be implemented to operate a wide beam width that supports small beam gains compared to the gNB 102. According to the implementation, the UEs 114, 115, and 116 may support one or more reception and transmission beams for downlink and uplink.

The beamforming in the downlink is based on the transmission beamforming of the base station or on a combination of the transmission beamforming of the base station and the reception beamforming of the UE. For the downlink beamforming, it may be necessary to perform a downlink beam tracking procedure, in which a best beam pair is selected from among one or more base station transmission beams and one or more UE reception beams generated in various directions according to the structure of each UE and base station, so that both the base station and the UE recognize information on the beam combination. The measurement of a reference signal (RS) (e.g., SSB, CSI-RS, etc.) transmitted from the base station may be used to select the best beam pair for the transmission beams of the base station and the reception beams of the UE in the downlink.

The gNB 102 may operate multiple transmission and reception beams 124 toward different directions for the downlink (DL)/uplink (UL) within one sector, and the UEs 114, 115, and 116 may support one or more transmission and reception beams, respectively.

Referring to FIG. 2, the gNB 102 may transmit multiple beamformed signals (i.e., transmission beams) simultaneously in different directions, or sequentially sweep one or more transmission beams toward different directions in time to transmit signals through the transmission beams.

According to the implementation, the UEs 114, 115, and 116 may support omnidirectional reception without supporting reception beamforming, receive a specific beamforming pattern by applying only one specific beamforming pattern at a time while supporting reception beamforming, or apply multiple reception beamforming patterns simultaneously in different directions while supporting reception beamforming, so as to ensure the maximum beamforming gain possible under the constraints of its shape and complexity.

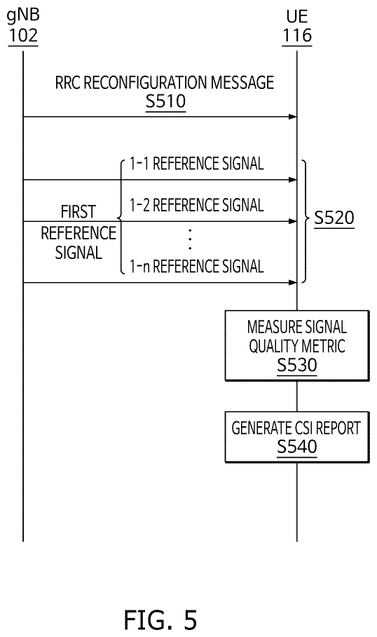

The UEs 114, 115, and 116 may provide feedback, to the gNB 102, the best transmission beam or measurement result selected from among the multiple transmission beams of the gNB 102 based on the measurement result of the reference signal for each transmission beam of the gNB 102. The gNB 102 may transmit a specific signal using the best transmission beam selected for each of the UEs 114, 115, and 116. For example, the UEs 114, 115, and 116 may generate a channel state information (CSI) report including the reference signal received power (L1-RSRP) value of the reference signal, and report the generated result to the gNB 102 to provide feedback, to the gNB 102, the best transmission beam or measurement result selected from among the multiple transmission beams. This will be described below in detail with reference to FIG. 5.

Each of the UEs 114, 115, and 116 supporting reception beamforming may measure the channel quality of each beam combination according to its multiple reception beams, select and manage the best one, top few, or all combinations of base station reception beams and terminal transmission beams, report the same to the base station, and receive signals using appropriate beam combinations according to the situation.

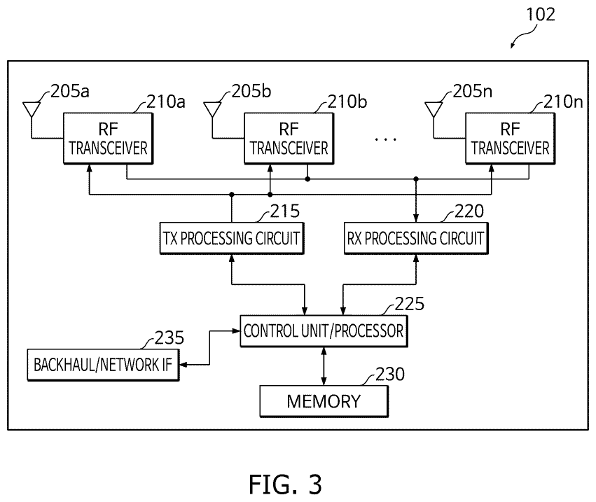

FIG. 3 illustrates an example gNB 102 according to some embodiments of the disclosure. The aspect of the gNB 102 illustrated in FIG. 3 is for illustration only, and the gNB 101 and 103 illustrated in FIG. 1 may have the same or similar settings. In some embodiments, the gNB may have various settings. FIG. 3 is not intended to limit the scope of the disclosure to any specific implementation of the gNB.

As illustrated in FIG. 3, the gNB 102 may include a plurality of antennas 205a to 205n (where, n is any natural number), a plurality of RF transceivers 210a to 210n, a transmit (TX) processing circuit 215, and a receive (RX) processing circuit 220. The gNB 102 may include a communication circuit. The communication circuit may include the RF transceivers 210a to 210n, the antennas 205a to 205n, the TX processing circuit 215, and the RX processing circuit 220. The gNB 102 may also include a control unit/processor 225, a memory 230, and a backhaul or network interface 235. The control unit and the processor of the control unit/processor 225 may be included in the gNB 102 as separate configurations.

The RF transceivers 210a to 210n may receive, from the antennas 205a to 205n, an incoming RF signal such as a signal transmitted by the UE in the wireless network 100. The RF transceivers 210a to 210n may down-convert the incoming RF signal to generate an intermediate frequency (IF) or baseband signal. The IF or baseband signal may be transmitted to the RX processing circuit 220 that filters, decodes and/or digitizes the baseband or IF signal to generate a processed baseband signal. The RX processing circuit 220 may transmit the processed baseband signal to the control unit/processor 225 for further processing.

The TX processing circuit 215 may receive analog or digital data such as voice data, web data, etc. from the control unit/processor 225. The TX processing circuit 215 may encode, multiplex, and/or digitize outgoing baseband data to generate a processed baseband or IF signal. The RF transceivers 210a to 210n may receive the processed outgoing baseband or IF signal from the TX processing circuit 215, and up-convert the baseband or IF signal into an RF signal to be transmitted through the antennas 205a to 205n.

The control unit/processor 225 may include one or more processors or other processing devices that control the overall operation of the gNB 102. For example, the control unit/processor 225 may control the reception of UL channel signals and transmission of DL channel signals by the RF transceivers 210a to 210n, the RX processing circuit 220, and the TX processing circuit 215 according to well-known principles. The control unit/processor 225 may also support additional functions such as more advanced wireless communication functions. For example, the control unit/processor 225 may support a beamforming or directional routing operation in which the outgoing signals from the plurality of antennas 205a to 205n are differently weighted so that the outgoing signals are effectively steered in a desired direction. Any of various other functions may be supported by the gNB 102 by the control unit/processor 225.

The control unit/processor 225 may also execute programs and other processes stored in the memory 230 such as the OS. The control unit/processor 225 may move data into and out of the memory 230 as required by the execution process.

The control unit/processor 225 may also be connected to the backhaul or network interface 235. The backhaul or network interface 235 may enable the gNB 102 communicate with other devices or systems through a backhaul connection or network. The interface 235 may support communication over any suitable wired or wireless connection. For example, if the gNB 102 is implemented as part of a cellular communication system (e.g., supporting 5G, LTE, or LTE-A), the interface 235 may enable the gNB 102 to communicate with another gNB through wired or wireless backhaul connections. If the gNB 102 is implemented as an access point, the interface 235 may enable the gNB 102 to transfer to a greater network (such as the Internet) through a wired or wireless local area network or a wired or wireless connection. The interface 235 may include any suitable structure that supports communication over a wired or wireless connection, such as an Ethernet or RF transceiver.

The memory 230 may be connected to the control unit/processor 225. A part of the memory 230 may include a RAM, and another part of the memory 230 may include a flash memory or another ROM.

FIG. 3 illustrates an example of the gNB 102, but various changes to FIG. 3 may be possible. For example, the gNB 102 may include any number of respective components illustrated in FIG. 3. As a specific example, the access point may include multiple interfaces 235, and the control unit/processor 225 may support UE beam activation in the wireless communication system. As another specific example, it is illustrated that the gNB 102 includes a single instance of the TX processing circuit 215 and a single instance of the RX processing circuit 220, but the gNB 102 may include respective multiple instances (such as one per RF transceiver). In addition, the various components of FIG. 3 may be combined, further subdivided, or omitted, and additional components may be added according to specific needs.

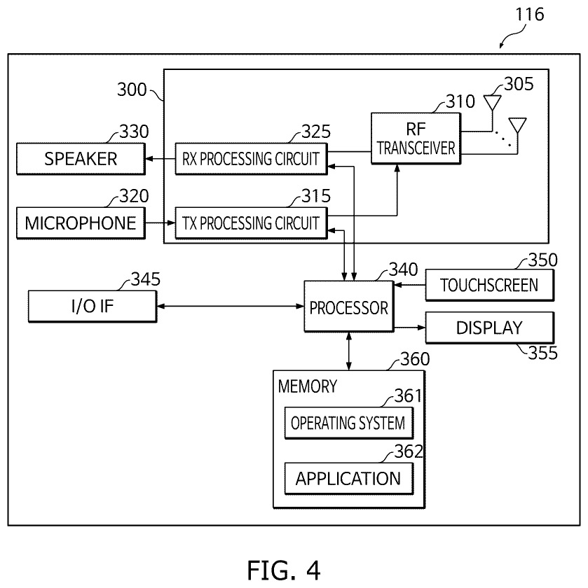

FIG. 4 illustrates an example of an UE 116 according to some embodiments of the disclosure. The aspect of the UE 116 illustrated in FIG. 4 is for illustration purposes only, and the UE 111 to 115 illustrated in FIG. 1 may have the same or similar settings. In an embodiment, the UE may have various settings. FIG. 4 does not limit the scope of the disclosure to any specific implementation of the UE.

As illustrated in FIG. 4, the UE 116 may include an antenna 305, a radio frequency (RF) transceiver 310, a TX processing circuit 315, a microphone 320, and a receive (RX) processing circuit 325. The UE 116 may include a communication circuit 300. The communication circuit 300 may include the RF transceiver 310, the antenna 305, the TX processing circuit 315, and the RX processing circuit 325. The UE 116 may also include a speaker 330, a processor 340, an input and output (I/O) interface (IF) 345, a touchscreen 350, a display 355, and a memory 360. The memory 360 may include an operating system (OS) 361 and one or more applications 362.

The RF transceiver 310 may receive, from the antenna 305, an incoming RF signal transmitted by the gNB of the wireless network 100. The RF transceiver 310 may down-convert the incoming RF signal to generate an intermediate frequency (IF) or baseband signal. The IF or baseband signal may be transmitted to the RX processing circuit 325 that filters, decodes and/or digitizes a baseband or IF signal to generate a processed baseband signal. The RX processing circuit 325 may transmit the processed baseband signal to the processor 340 for further processing.

The TX processing circuit 315 may receive analog or digital voice data from the microphone 320 or baseband data output from the processor 340. The TX processing circuit 315 may encode, multiplex, and/or digitize the output baseband data to generate a processed baseband or IF signal. The RF transceiver 310 may receive the processed outgoing baseband or IF signal from the TX processing circuit 315 and up-convert the baseband or IF signal into an RF signal to be transmitted through the antenna 305.

The processor 340 may include one or more processors or other processing devices, and may execute the OS 361 stored in the memory 360 to control the overall operation of the UE 116. For example, the processor 340 may control the reception of forward channel signals and transmission of reverse channel signals by the RF transceiver 310, the RX processing circuit 325, and the TX processing circuit 315 according to well-known principles. In some aspects, the processor 340 may include at least one microprocessor or microcontroller.

The processor 340 may also execute other processes and programs residing in the memory 360, such as a process for UE beam activation in the wireless communication system. The processor 340 may move data into and out of the memory 360 as required by an execution process. In some aspects, the processor 340 may be configured to execute the application 362 based on the OS 361 or in response to (or based on) a signal received from the gNB or operator. The processor 340 may also be connected to the I/O interface 345 that provides the UE 116 with the ability to connect to other devices such as a laptop computer and a handheld computer. The I/O interface 345 may be a communication path between an accessory and the processor 340 discussed above.

The processor 340 may also be connected to the touchscreen 350 and the display 355. The operator of the UE 116 may input data to the UE 116 using the touchscreen 350. The display 355 may be another display capable of rendering text and/or at least limited graphics, such as a liquid crystal display, a light emitting diode display, a website, etc.

The memory 360 may be connected to the processor 340. A part of the memory 360 may include a random access memory (RAM), and the other part of the memory 360 may include a flash memory or other read-only memory (ROM).

FIG. 4 illustrates an example of the UE 116, but various changes to FIG. 4 may be possible. For example, the various components of FIG. 4 may be combined, further subdivided, or omitted, and additional components may be added according to specific needs. As a specific example, the processor 340 may be divided into a plurality of processors such as one or more central processing units (CPUs) and one or more graphics processing units (GPUs). Additionally, FIG. 4 illustrates the UE 116 established as a mobile phone or smart phone, but UE may be set to operate as a different type of mobile or stationary device.

FIG. 5 illustrates a process of generating a channel state information (CSI) report. The CSI report is intended to provide feedback, to the gNB 102, the best transmission beam selected from among multiple transmission beams for which the reference signal is transmitted from the gNB 102, or its measurement result, and the CSI report may be generated by the UE 116 and transmitted to the gNB 102.

The gNB 102 may transmit a radio resource control (RRC) reconfiguration message to the UE 116, at S510. The RRC reconfiguration message may include information such as new radio resource configuration, frequency change, and cell reselection, through which the gNB 102 may instruct the UE 116 to update the radio resource control configuration. For example, through the RRC reconfiguration message, the gNB 102 may instruct the UE 116 to measure specific reference signals or channel state information so as to monitor and optimize network status.

The RRC reconfiguration message may include information instructing the UE 116 to generate a CSI report. For example, the RRC reconfiguration message may include information that instructs the UE 116 to receive a reference signal in a specific frequency band, determine and estimate the associated signal quality metric, and report the result in the form of a CSI report. The RRC reconfiguration message may specify the number of reference signals (e.g., top 1 to 4 reference signals based on the strength of the signal quality metric) to report the strength of the signal quality metric through the CSI report. The RRC reconfiguration message may include information indicating a period of generation and transmission of the CSI report.

The gNB 102 may transmit a first reference signal to the UE 116, at S520. The first reference signal may be a synchronization signal block (SSB) or a control resource indicator reference signal (CRI-RS). The UE 116 (or a communication circuit of the UE 116) may receive the transmitted first reference signal.

The first reference signal may include a plurality of first reference signals (first reference signals (1-1) to (1-n)). Each of the first reference signals (1-1) to (1-n) may be a resource (single-port resource) transmitted to the UE 116 through a single antenna port of the gNB 102.

The UE 116 (or a processor of the UE 116) may measure a signal quality metric of each of the plurality of received first reference signals, at S530. The signal quality metric measured at the UE 116 may be a reference signal received power (RSRP) and/or a signal to interference plus noise ratio (SINR).

The UE 116 (or the processor of the UE 116) may generate a channel state information (CSI) report based on the measured signal quality metric, at S540. The CSI report may be generated based on the information included in the RRC reconfiguration message.

The CSI report may include information associated with the first reference signal of the plurality of first reference signals that has the strongest signal quality metric. For example, the CSI report may include an index of the first reference signal of the plurality of first reference signals that has the strongest signal quality metric, and the signal quality metric value of that first reference signal. Additionally, the CSI report may include an index of a predetermined number (e.g., four) of first reference signals of the plurality of first reference signals in the order of stronger signal quality metric and a signal quality metric value thereof. The UE 116 may receive data transmitted from the gNB 102 in the direction of a specific beam associated with the first reference signal having the strongest signal quality metric.

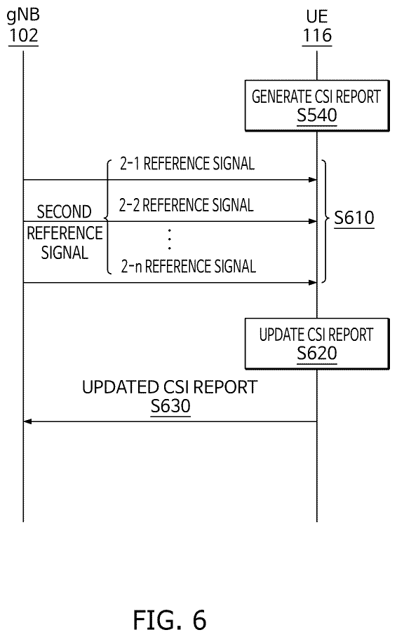

The CSI report generated in operation S540 is generated based on a reference signal transmitted using a single antenna port of the gNB 102 and received using a single antenna port of the UE 116, and may not be able to reflect the signal quality metrics in a multi-port environment where data is transmitted and received between the gNB 102 and the UE 116 using a plurality of antenna ports. Therefore, there is a need to update the generated CSI report using separate reference signals transmitted and received between the gNB 102 and the UE 116 through a plurality of antenna ports. This will be described below in detail below with reference to FIGS. 6 to 13.

FIG. 6 illustrates a process of updating a CSI report. The gNB 102 may transmit a second reference signal to the UE 116 to update the CSI report, at S610. The UE 116 (or the communication circuit of the UE 116) may receive the transmitted second reference signal. For example, the UE 116 may receive the second reference signal from the gNB 102 through a plurality of first antenna ports. The second reference signal may include a plurality of second reference signals (second reference signals (2-1) to (2-n)).

Each of the plurality of second reference signals may be a resource (multi-port resource) transmitted to the UE 116 through a plurality of second antenna ports of the gNB 102. In other words, the first reference signal and the second reference signal may be different types of reference signals. The second reference signal may include a channel state information reference signal (CSI-RS).

Each of the plurality of second reference signals may have a quasi-colocation (QCL) relationship with each of the plurality of first reference signals received in FIG. 5. For example, it may be considered that each of the plurality of second reference signals is transmitted to the UE 116 through the same channel as each of the plurality of first reference signals. In response to (or based on) identifying that a plurality of second reference signals each having a QCL relationship with a plurality of first reference signals are received from the gNB 102, the UE 116 may perform a CSI report update process using the plurality of second reference signals.

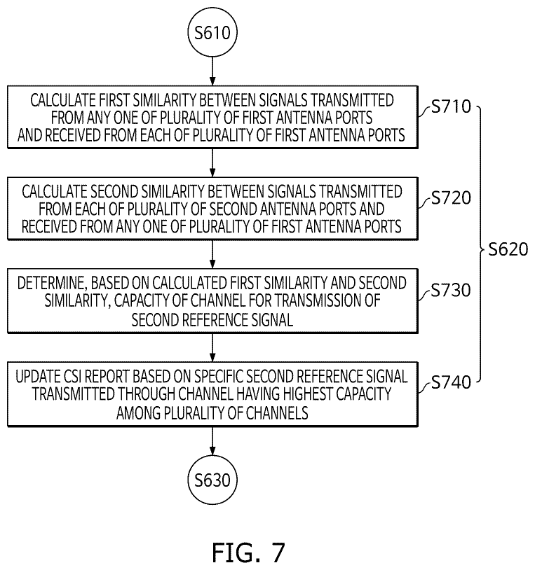

The UE 116 (or the processor of the UE 116) may update the generated CSI report based on the plurality of received second reference signals, at S620. Details of the process of updating the CSI report will be described below in detail with reference to FIG. 7.

The UE 116 (or the communication circuit of the UE 116) may transmit the updated CSI report to the gNB 102, at S630.

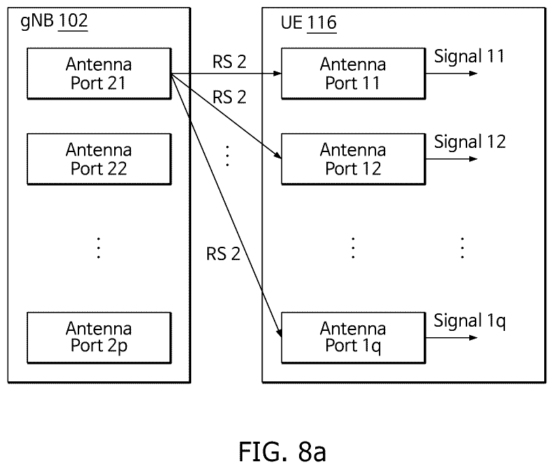

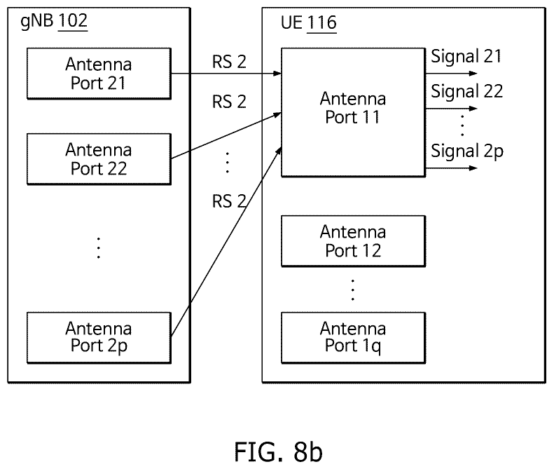

FIG. 7 illustrates an operation S620 of FIG. 6 in detail, FIG. 8A is a view provided to explain an operation S710 of FIG. 7, and FIG. 8B is a view provided to explain an operation S720 of FIG. 7. Each of the operations illustrated in FIG. 7 may be performed by the UE 116 (or the processor of the UE 116). In addition, the operations illustrated in FIG. 7 may each represent a process of calculating a capacity of a channel for any one of the second reference signals (e.g., the second reference signal (2-1) of FIG. 6) of the plurality of second reference signals (e.g., second reference signals (2-1) to (2-n) in FIG. 6) and updating a CSI report based on the calculated result. Each of the plurality of second reference signals may be transmitted from the plurality of second antenna ports of the gNB 102 and received by the plurality of first antenna ports of the UE 116.

Referring to FIGS. 7 and 8A, the gNB 102 may transmit the same signal RS2 to each of the plurality of first antenna ports (Antenna Ports 11 to 1q (where, q is any natural number equal to or greater than 2)) of the UE 116 through any one of the plurality of second antenna ports (Antenna Ports 21 to 2, where p is any natural number equal to or greater than 2), such as Antenna Port 21. The signal RS2 transmitted from any one (e.g., Antenna Port 21) of the second antenna ports may be at least part of a specific second reference signal (e.g., the second reference signal (2-1) of FIG. 6).

Signals (Signals 11 to 1q) received by the plurality of first antenna ports (Antenna Ports 11 to 1q) may be different from each other due to factors such as signal interference between antenna ports. The UE 116 may calculate a first similarity between signals (Signals 11 to 1q) received from each of the plurality of first antenna ports (Antenna Ports 11 to 1q), at S710.

Likewise, for each of the other second antenna ports (Antenna Ports 22 to 2p) of the gNB 102, the same signal may be transmitted to the plurality of first antenna ports (Antenna Ports 11 to 1q), and a first similarity between signals received from each of the plurality of first antenna ports (Antenna Ports 11 to 1q) may be calculated to calculate a plurality of first similarities. That is, the plurality of first similarities may represent a correlation between the plurality of first antenna ports (Antenna Ports 11 to 1q) when the signal is received from each of the plurality of second antenna ports (Antenna Ports 21 to 2p).

Referring to FIGS. 7 and 8B, the gNB 102 may transmit the same signal RS2 to any one (e.g., Antenna Port 11) of the plurality of first antenna ports (Antenna Ports 11 to 1q) of the UE 116 through the plurality of second antenna ports (Antenna Ports 21 to 2p). The signal RS2 transmitted to any one (e.g., Antenna Port 11) of the first antenna ports may be at least a part of a specific second reference signal (e.g., at least part of the second reference signal (2-1) of FIG. 6).

The signals (Signals 21 to 2p) received at any one (Antenna Port 11) of the first antenna ports may be different from each other due to factors such as signal interference between antenna ports. The UE 116 may calculate a second similarity between signals (Signals 21 to 2p) received from any one (e.g., Antenna Port 11) of the first antenna ports, at S720.

Likewise, the gNB 102 may transmit the same signal to the other first antenna ports (Antenna Ports 12 to 1q) of UE 116 through the plurality of second antenna ports (Antenna Ports 21 to 2p), and calculate the second similarity between signals received from each of the other first antenna ports (Antenna Ports 12 to 1q). Accordingly, a plurality of second similarities may be calculated. That is, the plurality of first similarities may represent a correlation between the plurality of second antenna ports (Antenna Ports 21 to 2p) when the signal is transmitted to the plurality of first antenna ports (Antenna Ports 11 to 1q).

Referring again to FIG. 7, the UE 116 may determine the capacity of a channel for transmission of the second reference signal based on the calculated first and second similarities, at S730. For the channel for transmission of a specific second reference signal, the UE 116 may determine a correlation (or a correlation coefficient) between the plurality of first antenna ports of the UE 116 based on the plurality of first similarities calculated in operation S710, and determine a correlation (or a correlation coefficient) between the plurality of second antenna ports of the gNB 102 based on the plurality of second similarities calculated in operation S720.

The UE 116 may determine the capacity of the channel for transmission of the second reference signal based on the correlation between the plurality of first antenna ports and the correlation between the plurality of second antenna ports. For example, the lower the correlation coefficient between the plurality of first antenna ports or plurality of second antenna ports transmitting and receiving a specific second reference signal, the more likely that each antenna port may transmit information independent of the other, and thus, the greater capacity may be determined for the channel for transmission of the second reference signal. On the other hand, the greater the correlation coefficient between the plurality of first antenna ports or plurality of second antenna ports transmitting and receiving a specific second reference signal, the more likely that the information transmitted and received between the antenna ports may overlap and have interferences, resulting in deteriorating transmission performance, and thus, the lower capacity may be determined for the channel for transmission of the second reference signal.

Likewise, the UE 116 may determine the capacity of not only the channel for transmission of the specific second reference signal described above, but also the capacity of each of the plurality of channels for transmission of the plurality of second reference signals (e.g., second reference signals (2-1) to (2-n) in FIG. 6).

The UE 116 may update the CSI report based on information associated with the specific second reference signal transmitted through a channel of the greatest capacity among the plurality of channels, at S740.

The UE 116 may update the CSI report such that the signal quality metric of the specific first reference signal having a QCL relationship with the specific second reference signal transmitted through the channel of the greatest capacity among the plurality of channels is the strongest signal quality metric.

In another example, the UE 116 may assign weight to a signal quality metric of a specific first reference signal having a QCL relationship with a specific second reference signal. In response to (or based on) the weighted signal quality metric of the first reference signal being determined as the highest signal quality metric, the UE 116 may update the CSI report such that the weighted signal quality metric of the first reference signal is the strongest signal quality metric. The greater the capacity of the channel for transmission of a specific first reference signal, the greater the weight assigned to the signal quality metric of that first reference signal.

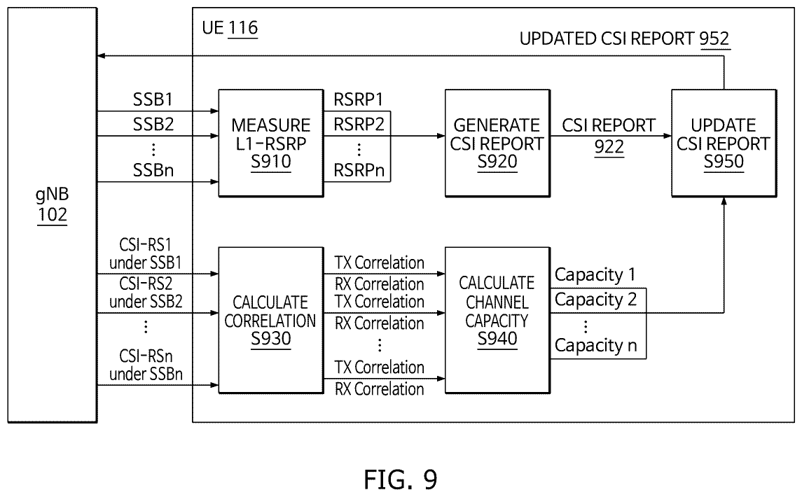

FIG. 9 illustrates a process of updating a CSI report. Each of the operations illustrated in FIG. 9 may be performed by the UE 116 (or the processor of the UE 116), and the reference numerals given to each of the operations do not necessarily indicate a sequential order in time.

The UE 116 may receive a plurality of SSBs (SSB1 to SSBn) corresponding to the plurality of first reference signals from the gNB 102 and measure the L1-RSRP (RSRP1 to RSRPn) for each of the plurality of SSBs (SSB1 to SSBn), at S910. The operation S910 of FIG. 9 may correspond to the operation S530 of FIG. 5. Alternatively, the UE 116 may receive a plurality of CRI-RSs as the plurality of first reference signals, or measure an SINR for the plurality of SSBs or the plurality of CRI-RSs.

The UE 116 may generate a CSI report 922 based on a plurality of measured RSRP values (RSRP1 to RSRPn), at S920. For example, the UE 116 may generate the CSI report 922 including an index of SSB having the strongest RSRP value among the plurality of RSRP values (RSRP1 to RSRPn) and the corresponding RSRP value. The operation S920 of FIG. 9 may correspond to the operation S540 of FIG. 5.

In an embodiment, the UE 116 may receive, as a plurality of second reference signals, a plurality of CSI-RSs (CSI-RS1 to CSI-RSn) having a QCL relationship with the plurality of SSBs (SSB1 to SSBn), and calculate a correlation coefficient for each of the plurality of received CSI-RSs (CSI-RS1 to CSI-RSn), at S930. For example, TX correlation between the plurality of antenna ports of the gNB 102 transmitting each of the plurality of CSI-RSs (CSI-RS1 to CSI-RSn) and RX correlation between the plurality of antenna ports of the UE 116 receiving the same may be calculated for each of the plurality of CSI-RSs (CSI-RS1 to CSI-RSn).

Based on the TX correlation between the plurality of antenna ports of the gNB 102 and the RX correlation between the plurality of antenna ports of the UE 116, the UE 116 may calculate corresponding capacities (Capacities 1 to n) of the channel for transmission and reception of the CSI-RS, at S940. For example, the lower the correlation coefficient (TX correlation) between the plurality of antenna ports of the gNB 102 or the correlation coefficient (RX correlation) between the plurality of antenna ports of the UE 116, the greater the capacity of the channel may be calculated. The operation S940 of FIG. 9 may correspond to the operation S730 of FIG. 7.

The UE 116 may update the CSI report based on the calculated capacities (Capacities 1 to n) of each of the plurality of channels, at S950. For example, the UE 116 may update the CSI report such that the L1-RSRP of a specific SSB, which is in a QCL relationship with the CSI-RS transmitted through the channel with the highest capacity, becomes the strongest L1-RSRP. The operation S950 of FIG. 9 may correspond to the operation S620 of FIG. 6.

The UE 116 may transmit the updated CSI report 952 to the gNB 102 (This corresponds to the operation S630 of FIG. 6).

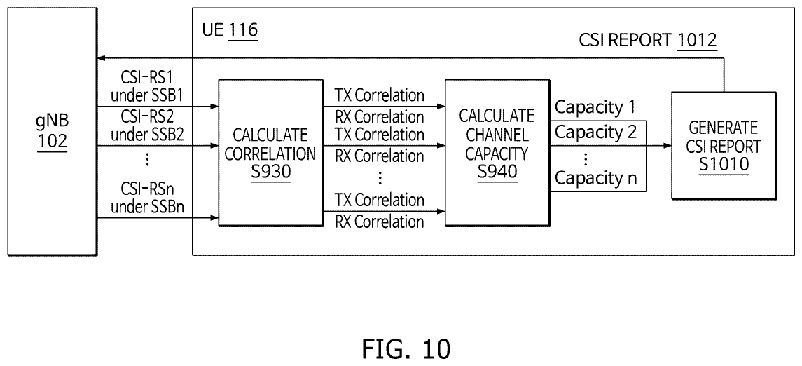

FIG. 10 illustrates a modification of FIG. 9. Unlike the aspect illustrated and described with reference to FIG. 9, the operations S910 and S920 of FIG. 9 are omitted, and the UE 116 may generate a CSI report 1012 such that the L1-RSRP of a specific SSB having a QCL relationship with the CSI-RS transmitted through the greatest capacity channel is the strongest L1-RSRP, at S1010. That is, the UE 116 may generate a CSI report such that the signal quality metric of the specific first reference signal having a QCL relationship with the specific second reference signal transmitted through the channel of the greatest capacity of the plurality of channels is the strongest signal quality metric.

The UE 116 may transmit the generated CSI report 1012 to the gNB 102.

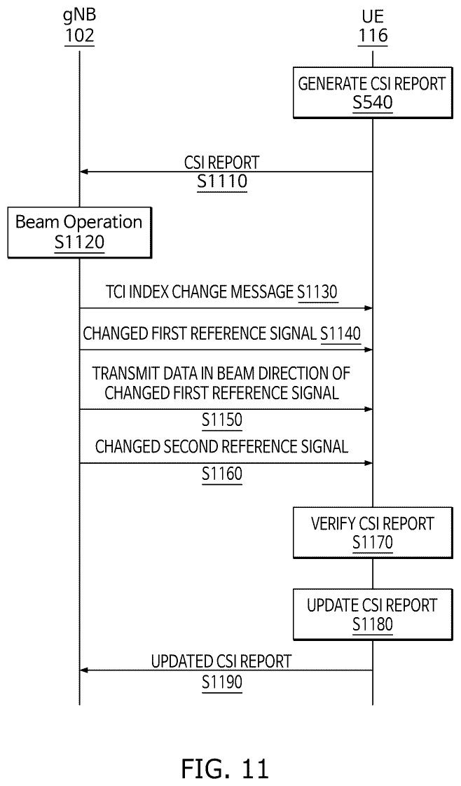

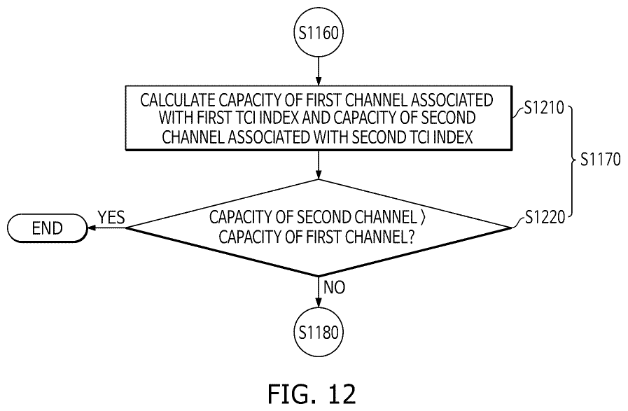

FIG. 11 illustrates a process of performing validity verification and update of a CSI report. FIG. 12 illustrates an operation S1170 of FIG. 11 in detail.

Unlike the aspects illustrated and described with reference to FIGS. 6 to 10, the UE 116 (or the communication circuit of the UE 116) may transmit the CSI report generated in the operation S540 of FIG. 5 to the gNB 102, at S1110.

The gNB 102 may perform a beam operation based on the CSI report received from the UE 116, at S1120. For example, the gNB 102 may change a transmission configuration identification (TCI) index to transmit signals to the UE 116 in the beam direction of the first reference signal that is specified on the CSI report as having the strongest signal quality metric.

In response to (or based on) receiving the CSI report, the gNB 102 may transmit a TCI index change message indicating a change from a previous first transmission configuration indicator (TCI) index to a second TCI index to the UE 116 (or, to the communication circuit of the UE 116), at S1130. In response to (or based on) receiving the TCI index change message, the UE 116 may perform an operation for receiving a signal through a new beam direction.

In response to (or based on) the change of the TCI index from the first TCI index to the second TCI index, the gNB 102 may transmit the changed first reference signal to the UE 116 (or, to the communication circuit of the UE 116) in the new beam direction, at S1140. The gNB 102 may transmit data to the UE 116 (or, to the communication circuit of the UE 116) in the beam direction of the changed first reference signal, at S1150. For example, the gNB 102 may transmit a physical downlink shared channel (PDSCH) data to the UE 116 in the beam direction of the changed reference signal.

In an embodiment, the gNB 102 may transmit a second reference signal generated based on the first TCI index to the UE 116 (or, to the communication circuit of the UE 116) at any point before the TCI index is changed.

After the TCI index is changed, the second reference signal may be changed based on the second TCI index, and the gNB 102 may transmit the changed second reference signal to the UE 116 (or, to the communication circuit of the UE 116) (S1160). The second reference signal transmitted from the gNB 102 may be a single second reference signal (e.g., CSI-RS). The single second reference signal may be a reference signal having a non-QCL relationship with the first reference signal.

The single second reference signal may include a reference signal transmitted and received using a plurality of antenna ports in each of the gNB 102 and the UE 116. For example, the single second reference signal may include CSI-RS and/or physical downlink shared channel-demodulation reference signal (PDSCH-DMRS). In response to (or based on) the absence of CSI-RS, the PDSCH-DMRS assigned for data decoding may be used as the single second reference signal.

The UE 116 (or the processor of the UE 116) may verify the validity of the CSI report transmitted to the gNB 102 based on the received changed second reference signal, at S1170.

Referring to FIGS. 11 and 12, the UE 116 may calculate the capacity of a first channel through which the second reference signal associated with the first TCI index is transmitted, and the capacity of a second channel through which the second reference signal associated with the second TCI index is transmitted before the TCI index is changed, at S1210.

The capacity of the first channel and the capacity of the second channel may be calculated by the same/similar process as the process illustrated and described with reference to FIGS. 8A and 8B. For example, a single second reference signal may be transmitted through the plurality of second antenna ports of the gNB 102 and received through the plurality of first antenna ports of the UE 116. The UE 116 may calculate the capacity of the channel based on the first similarity between signals transmitted from any one of the plurality of second antenna ports and received by each of the plurality of first antenna ports, and the second similarity between signals transmitted from each of the plurality of second antenna ports and received by any one of the plurality of first antenna ports.

The UE 116 may verify the validity of the TCI index change based on the capacity of the first channel and the capacity of the second channel. For example, if the capacity of the second channel is greater than the capacity of the first channel (yes in S1220), the UE 116 may determine that the TCI index change by the CSI report is valid and terminate the process of FIG. 11. Conversely, if the capacity of the second channel is lower than the capacity of the first channel (no in S1220), the UE 116 may determine that the TCI change is not valid because the data transmission and reception performance is deteriorated.

In response to (or based on) determining that the TCI change is not valid, the UE 116 (or the processor of the UE 116) may update the CSI report to change from the second TCI index to the previous first TCI index, at S1180.

The UE 116 (or the communication circuit of the UE 116) may transmit the updated CSI report to the gNB 102, at S1190.

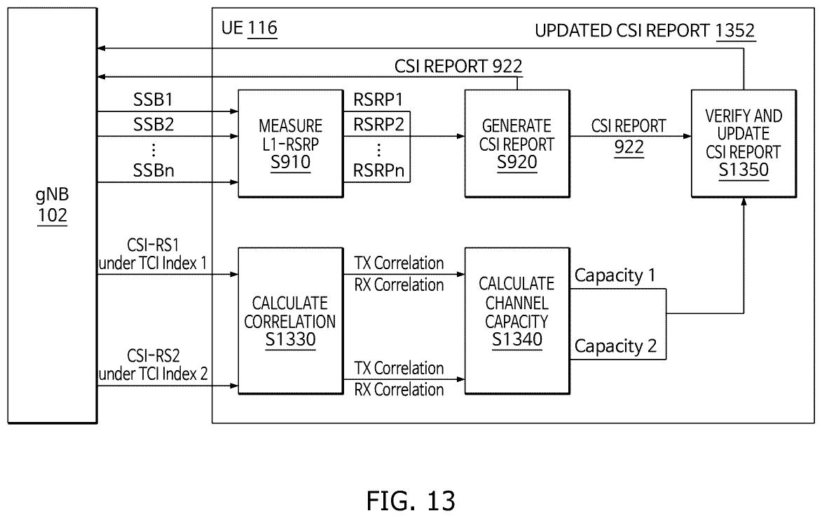

FIG. 13 illustrates a process of verifying and updating a CSI report. Each of the operations illustrated in FIG. 13 may be performed by the UE 116 (or the processor of the UE 116). The reference numerals given to each of the operations do not necessarily indicate a sequential order in time.

Unlike FIG. 9, the CSI report 922 generated in the operation S920 may be transmitted to the gNB 102.

In an embodiment, the UE 116 may receive CSI-RS (CSI-RS1 under TCI Index 1) associated with the first TCI index before the TCI change and CSI-RS (CSI-RS2 under TCI Index 2) associated with the second TCI index after the TCI change, and calculate a TX correlation between a plurality of antenna ports of the gNB 102 transmitting each CSI-RS and a RX correlation between a plurality of antenna ports of the UE 116 receiving each CSI-RS, at S1330. Conversely, in response to (or based on) determining that the CSI-RS signal does not exist, the UE 116 may receive PDSCH-DMRS associated with the first TCI index before the TCI change and PDSCH-DMRS associated with the second TCI index after the TCI change, and calculate a correlation between a plurality of antenna ports of the gNB 102 associated with the same and a correlation between a plurality of antenna ports of the UE 116.

The UE 116 may calculate the capacity (Capacity 1 and 2) of each of the first and second channels for transmission and reception of CSI-RS1 and CSI-RS2 based on the TX correlation between the plurality of antenna ports of the gNB 102 and the RX correlation between the plurality of antenna ports of the UE 116, at S1340. For example, the lower the TX correlation between the plurality of antenna ports of the gNB 102 or the RX correlation between the plurality of antenna ports of the UE 116, the greater the capacity of the channel may be calculated. The operation S1340 of FIG. 13 may correspond to the operation S1210 of FIG. 12.

The UE 116 may verify and update the CSI report based on the calculated capacity (Capacity 1 and 2) of each of the first and second channels, at S1350. For example, in response to (or based on) verifying that the TCI change by the CSI report is not valid, the UE 116 may update the CSI report to change from the second TCI index to the previous first TCI index. In this case, the UE 116 may transmit the updated CSI report 1352 to the gNB 102.

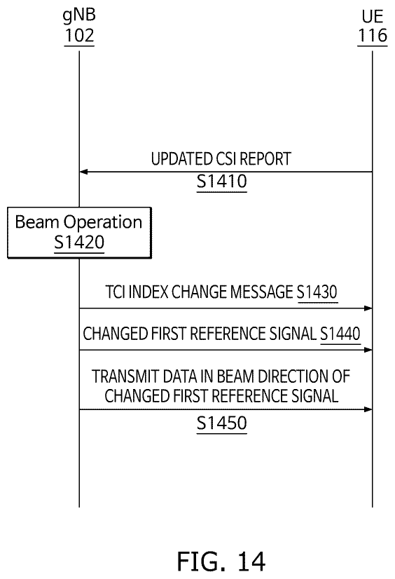

FIG. 14 illustrates a process performed as the updated CSI report is transmitted to the gNB 102.

The UE 116 (or the communication circuit of the UE 116) may transmit the updated CSI report to the gNB 102, at S1410. The operation S1410 of FIG. 14 may correspond to the operation S630 of FIG. 6 or the operation S1190 of FIG. 11.

The gNB 102 may perform a beam operation based on the updated CSI report, at S1420. For example, the gNB 102 may change the TCI index.

In response to (or based on) receiving the updated CSI report, the gNB 102 may transmit a message for changing the previous TCI index to the UE 116 (or, to the communication circuit of the UE 116), at S1430. In response to (or based on) receiving the TCI index change message, the UE 116 may perform a preparation operation for receiving a signal in a new beam direction.

In response to (or based on) the change of the TCI index, the gNB 102 may transmit the changed first reference signal to the UE 116 (or, to the communication circuit of the UE 116) in the new beam direction, at S1440. The gNB 102 may transmit data to the UE 116 (or, to the communication circuit of the UE 116) in the beam direction of the changed first reference signal, at S1450. For example, the gNB 102 may transmit a physical downlink shared channel (PDSCH) data to the UE 116 in the beam direction of the changed reference signal.

Through this, the best beam direction between the gNB 102 and the UE 116 may be derived in a MIMO wireless communication environment based on a Tx-Rx multi-port environment.

The disclosure is not limited to the aspects described above and the accompanying drawings, and various forms of substitution, modification, and change will be possible by those of ordinary skill in the art without departing from the technical idea of the disclosure described in the claims, which also fall within the scope of the disclosure. For example, one or more operations in the process illustrated and described with reference to FIGS. 1 to 14 may be omitted, the order of each of the operations may be changed, one or more operations may be temporally overlapped, or one or more operations may be repeatedly performed several times.

What is claimed is:

1. A user equipment comprising:
a communication circuit configured to receive, from a serving base station, a plurality of first reference signals transmitted through a plurality of transmission beams; and
a processor configured to measure signal quality metrics of the plurality of first reference signals and generate a channel state information (CSI) report based on the measured signal quality metrics,
wherein the communication circuit is further configured to receive, through a plurality of first antenna ports, at least one second reference signal from the serving base station, and
wherein the processor is further configured to generate, based on the at least one second reference signal and the CSI report, an updated CSI report.

2. The user equipment of claim 1, wherein the communication circuit is further configured to transmit the updated CSI report to the serving base station.

3. The user equipment of claim 2, wherein the CSI report comprises information associated with a first reference signal having a strongest signal quality metric among the plurality of first reference signals, and
wherein the communication circuit is further configured to receive data transmitted from the serving base station in a specific beam direction associated with the first reference signal having the strongest signal quality metric.

4. The user equipment of claim 3, wherein the at least one second reference signal comprises a plurality of second reference signals, and
wherein each second reference signal of the plurality of second reference signals has a quasi-colocation (QCL) relationship with a respective first reference signal of the plurality of first reference signals.

5. The user equipment of claim 4, wherein the processor is further configured to:
determine a capacity of each channel of a plurality of channels that transmit the plurality of second reference signals; and
update the CSI report based on information associated with a specific second reference signal transmitted through a channel having a greatest capacity among the plurality of channels.

6. The user equipment of claim 5, wherein the processor is further configured to update the CSI report such that a signal quality metric of a specific first reference signal having a QCL relationship with the specific second reference signal is a strongest signal quality metric.

7. The user equipment of claim 5, wherein the processor is further configured to:
assign a weight to a signal quality metric of a specific first reference signal having a QCL relationship with the specific second reference signal; and
based on the weighted signal quality metric of the specific first reference signal being determined to be a strongest signal quality metric, update the CSI report such that the weighted signal quality metric of the first reference signal is the strongest signal quality metric.

8. The user equipment of claim 5, wherein the specific second reference signal is transmitted through a plurality of second antenna ports of the serving base station, and received through at least one of the plurality of first antenna ports of the user equipment, and
wherein the processor is further configured to determine a capacity of a channel that transmits the specific second reference signal based on:
a first similarity between signals transmitted from any one of the plurality of second antenna ports and received from each of the at least one of the plurality of first antenna ports; and
a second similarity between signals transmitted from each of the plurality of second antenna ports and received from any one of the at least one of the plurality of first antenna ports.

9. The user equipment of claim 1, wherein the plurality of first reference signals comprise a plurality of synchronization signal blocks (SSBs) or a plurality of control resource indicator reference signals (CRI-RSs).

10. The user equipment of claim 1, wherein the at least one second reference signal comprises a channel state information reference signal (CSI-RS).

11. The user equipment of claim 1, wherein the plurality of first reference signals are different from the at least one second reference signal.

12. The user equipment of claim 1, wherein each of the signal quality metrics comprises a reference signals received power (RSRP) or a signal to interference plus noise ratio (SINR).

13. The user equipment of claim 1, wherein the at least one second reference signal comprises a single second reference signal, and
wherein the single second reference signal has a non-quasi-colocation (non-QCL) relationship with the plurality of first reference signals.

14. The user equipment of claim 13, wherein the processor is further configured to:
transmit a CSI report to the serving base station;
based on the CSI report being transmitted to the serving base station, receive a transmission configuration indicator (TCI) index change message indicating a change from a first TCI index to a second TCI index;
determine a capacity of a first channel associated with the first TCI index and a capacity of a second channel associated with the second TCI index; and
verify a validity of the TCI index change based on the capacity of the first channel and the capacity of the second channel.

15. The user equipment of claim 14, wherein the processor is further configured to:
determine whether the capacity of the second channel is lower than the capacity of the first channel; and
based on determining that the capacity of the second channel is lower than the capacity of the first channel, update the CSI report to change from the second TCI index to the first TCI index, and
wherein the communication circuit is further configured to transmit the updated CSI report to the serving base station.

16. The user equipment of claim 14, wherein the single second reference signal is transmitted through a plurality of second antenna ports of the serving base station and received through at least one of the plurality of first antenna ports of the user equipment, and
wherein the processor is further configured to determine a capacity of a channel for transmission of the single second reference signal based on:
a first similarity between signals transmitted from any one of the plurality of second antenna ports and received from each of the at least one of the plurality of first antenna ports; and
a second similarity between signals transmitted from each of the plurality of second antenna ports and received from any one of the at least one of the plurality of first antenna ports.

17. The user equipment of claim 13, wherein the single second reference signal comprises a physical downlink shared channel-demodulation reference signal (PDSCH-DMRS).

18. The user equipment of claim 1, wherein the CSI report comprises:
an index of a first reference signal having a strongest signal quality metric among the plurality of first reference signals, and
a signal quality metric value of the first reference signal having the strongest signal quality metric.

19. A user equipment comprising:
a communication circuit configured to:
receive, from a serving base station, a plurality of first reference signals transmitted through a plurality of transmission beams, and
receive, through a plurality of first antenna ports, a plurality of second reference signals, each second reference signal of the plurality of second reference signals having a quasi-colocation (QCL) relationship with a respective first reference signal of the plurality of first reference signals; and
a processor configured to:
determine a capacity of each channel of a plurality of channels that transmit the plurality of second reference signals, and
generate a CSI report such that a signal quality metric of a specific first reference signal is a strongest signal quality metric,
wherein the specific first reference signal has a QCL relationship with a specific second reference signal transmitted through a channel having a greatest capacity among the plurality of channels, and
wherein the communication circuit is further configured to transmit the generated CSI report to the serving base station.

20. A method for generating a channel state information (CSI) report, the method comprising:
receiving, by a communication circuit of a user equipment, from a serving base station, a plurality of first reference signals transmitted through a plurality of transmission beams;
measuring, by a processor of the user equipment, signal quality metrics of the plurality of first reference signals;
based on the measured signal quality metrics, generating, by the processor, the CSI report;
receiving, by the communication circuit, at least one second reference signal from the serving base station through a plurality of first antenna ports; and
based on the CSI report and the at least one second reference signal received through the plurality of first antenna ports, generating, by the processor, an updated CSI report.
